(19) United States
(12) Patent Application Publication
(10) Pub. No.: US 2017/0259587 A1
(43) Pub. Date: Sep. 14, 2017

(54) PRINTING APPARATUS

(71) Applicant: SEIKO EPSON CORPORATION, Tokyo (JP)

(72) Inventors: Tomohiro YODA, Shiojiri-shi (JP); Naotoshi YANAGIDAIRA, Chino-shi (JP)

(21) Appl. No.: 15/451,837

(22) Filed: Mar. 7, 2017

(30) Foreign Application Priority Data
Mar. 14, 2016 (JP) 2016-049203

(51) Int. Cl. B41J 11/04; B41J 2/01

(52) U.S. Cl. CPC B41J 11/04; B41J 2/01

(57) ABSTRACT

A printing apparatus includes a printing portion that performs printing on a medium transported in a transport direction, a transport roller that supports the medium, a pressing roller that is capable of rotating with a width direction set as an axial direction and that press the medium down toward the transport roller, and a roller support portion that supports the pressing rollers so as to be capable of revolving with an axis of revolution, which is an axis of revolution in which a direction that intersects both directions of the transport direction and the width direction set as an axial direction thereof and which is positioned between an end portion of a first end side and an end portion of a second end side in the axial direction of the pressing rollers, set as a center thereof.

### BACKGROUND

1. Technical Field

The present invention relates to a printing apparatus such as an ink jet printer.

2. Related Art

In the related art, as an example of a printing apparatus, ink jet printers that perform printing of characters and images by discharging an ink onto a medium such as a sheet of paper, are known. Among such printing apparatuses, there are printing apparatuses that are provided with a transport roller that comes into contact with a rear surface of a medium, and a pressing roller (a driven roller) that comes into contact with the front surface of a medium and presses the medium down toward the transport roller, and that transport a medium toward printing portion by rotating the transport roller in a state in which the medium is held between the transport roller and the pressing roller (for example, JP-A-2009-202394).

Incidentally, in a printing apparatus such as that mentioned above, the transport roller and the pressing roller are rollers in which a width direction, which intersects a transport direction of the medium, is set as an axial direction thereof, and a plurality of the pressing rollers are provided at intervals in the width direction.

Therefore, in a printing apparatus such as that mentioned above, there are cases in which portions in which it is not possible for the plurality of pressing rollers to press a medium down toward the transport roller during transport of the medium, that is, wrinkling (lifting) of the medium occurs between adjacent pressing rollers. Further, when printing is performed on a medium transported in a state in which wrinkling occurs between adjacent pressing rollers, there is a concern that the printing quality will deteriorate as a result of the ink landing in a position that differs from normal.

### SUMMARY

An advantage of some aspects of the invention is to provide a printing apparatus that can support the occurrence of wrinkling in a medium during transport of the medium.

Hereinafter, means of the invention and operation effects thereof will be described.

According to an aspect of the invention, there is provided a printing apparatus including a printing portion that performs printing on a medium transported in a transport direction, a support portion that supports the medium, a plurality of pressing rollers that are capable of rotating with a width direction, which intersects the transport direction, set as an axial direction and that press the medium down toward the support portion, and a roller support portion that supports the pressing rollers so as to be capable of revolving with an axis of revolution, which is an axis of revolution in which a direction that intersects both directions of the transport direction and the width direction is set as an axial direction thereof and which is positioned between an end portion of a first end side and an end portion of a second end side in the axial direction of the pressing rollers, set as a center thereof.

In this configuration, since the pressing rollers are capable of revolving with the axis of revolution as the center thereof, it is possible to cause the pressing rollers disposed further on the outer side than a central position of the medium in the width direction, to revolve so as to be directed toward the outer side in the width direction. Further, when the pressing rollers disposed in this manner rotate in accordance with transport of the medium, a force that stretches the medium to the outer side in the width direction, acts on the medium. Therefore, even in a case in which sagging or lifting occurs in the medium in the width direction, since such sagging or lifting is elongated in the width direction, it is possible to make it unlikely for wrinkling to occur between adjacent pressing rollers. In addition, since the axis of revolution of a pressing roller is positioned between both end portions in the axial direction of the pressing roller, it is possible to reduce the size of a revolving range of the pressing roller in accordance with revolution of the pressing roller.

In addition, in the printing apparatus, it is preferable that the support portion be a transport roller that rotates with the width direction as an axial direction thereof, and apply a transport force for transporting the medium in the transport direction, to the medium.

In a case in which the pressing rollers are moved (revolved) relatively with respect to the support portion, when an axis of rotation of the pressing rollers and an axis of rotation of the support portion are positioned separated from one another in the transport direction, it is no longer possible to hold the medium between the pressing rollers and the support portion, and therefore, there are cases in which the transport force that the support portion can apply to the medium is small. For this reason, in this case, since the pressing rollers are caused to revolve with the axis of revolution positioned between both end portions in the axial direction of the pressing rollers as the center thereof, even if the pressing rollers are caused to revolve, it is unlikely that the axis of rotation of the pressing rollers and the axis of rotation of the support portion will be positioned separated from one another in the transport direction. Therefore, a state in which the medium is held between the pressing rollers and the support portion is retained, and therefore, it is possible to suppress a circumstance in which the transport force that the support portion can apply to the medium is small.

In addition, in the printing apparatus, it is preferable that the axis of revolution of the pressing rollers be positioned in a center in the axial direction of the pressing rollers.

In this configuration, it is possible to suppress a circumstance in which the end portion of the second end side in the width direction of the pressing rollers is disposed in a position that is separated from the support portion while suppressing a circumstance in which the end portion of the first end side in the width direction of the pressing rollers is disposed in a position that is separated from the support portion in the transport direction. Accordingly, the amount of positional shift in the transport direction of the pressing rollers with respect to the support portion is suppressed, and therefore, it is possible to suppress a circumstance in which the transport accuracy of the medium deteriorates.

In addition, in the printing apparatus, it is preferable that the roller support portion include a first arm that supports the end portion of the first end side of the pressing rollers in the width direction so as to be capable of rotating, and that can be moved along the transport direction, and a second arm that supports the end portion of the second end side of the pressing rollers in the width direction so as to be capable of rotating, and that can be moved along the transport direction.

According to the above-mentioned configuration, as a result of moving the second arm in one direction in the transport direction while moving the first arm in the other direction in the transport direction, it is possible to easily cause the pressing rollers to revolve around the axis of revolution.

In addition, in the printing apparatus, it is preferable that the roller support portion support the pressing rollers so that the pressing rollers revolve gradually.

In this configuration, since revolution of the pressing rollers is performed gradually, it is possible to easily perform adjustment of the angle of revolution of the pressing rollers.

In addition, in the printing apparatus, it is preferable that the roller support portion include a regulation portion that regulates revolution of the pressing rollers.

When the axial direction of a pressing roller is set as a direction that is different to the width direction, there is a concern that the angle of revolution of the pressing roller will be unintentionally changed as a result of a friction force with a medium that is transported acting on the pressing roller. For this reason, in this case, since revolution of the pressing rollers is suppressed by the regulation portion, it is possible to suppress a circumstance in which the angle of revolution of the pressing rollers is unintentionally changed.

### BRIEF DESCRIPTION OF THE DRAWINGS

The invention will be described with reference to the accompanying drawings, wherein like numbers reference like elements.

FIG. 1 is a side view of a printing apparatus according to an embodiment.

FIG. 2 is a plan view that shows a peripheral configuration of a transport portion of the printing apparatus.

FIG. 3 is a side view of a pressing portion of the transport portion.

FIG. 4 is a plan view of the pressing portion.

FIG. 5 is a bottom view of the pressing portion.

FIG. 6 is a plan view of the pressing portion in a state in which pressing rollers are revolved.

FIG. 7 is a plan view that shows a peripheral configuration of the transport portion in a state in which the pressing rollers are revolved.

FIG. 8 is a bottom view of a pressing portion according to a modification example.

### DESCRIPTION OF EXEMPLARY EMBODIMENTS

Hereinafter, an embodiment of a printing apparatus will be described with reference to the drawings. Additionally, a printing apparatus of the present embodiment is an ink jet printer that forms characters and images by discharging an ink onto a medium such as sheets of paper.

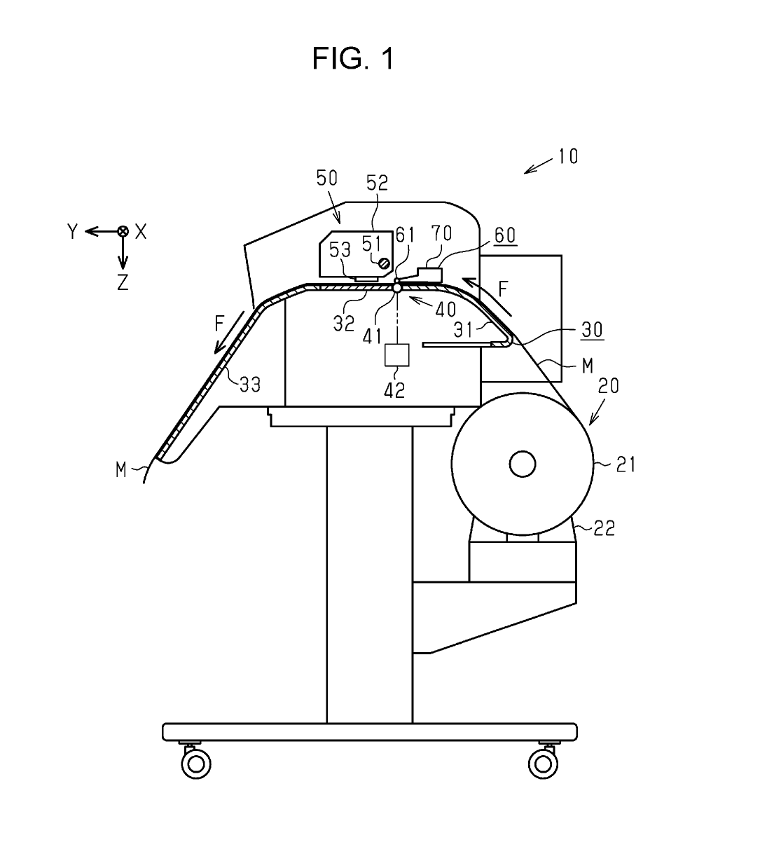

As shown in FIG. 1, a printing apparatus 10 is provided with a feed out portion 20 that feeds out a medium M, a guide portion 30 that guides the medium M, a transport portion 40 that transports the medium M, and a printing portion 50 that performs printing on the medium M.

Additionally, in the following description, the width direction of the printing apparatus 10 is set as a “width direction X”, the front-back direction of the printing apparatus 10 is set as a “front-back direction Y”, the vertical direction of the printing apparatus 10 is set as a “vertical direction Z”, and a direction in which the medium M is transported is set as a “transport direction F”. In addition, one end in the width direction X is set as a “first end X1”, and the other end in the width direction X is set as a “second end X2”. The width direction X, the front-back direction Y, and the vertical direction Z are directions that mutually intersect (are orthogonal to) one another, and the transport direction F is a direction that intersects (is orthogonal to) both directions of the width direction X and the vertical direction Z.

The feed out portion 20 includes a holding member 22 that holds a rolled body 21, around which the medium M is wound. Media M of different types and rolled bodies 21 having dimensions that differ in the width direction X are held by the holding member 22. Further, in the feed out portion 20, medium M unwound from the rolled body 21 is fed out toward the guide portion 30 by rotating the rolled body 21 in one direction (the anticlockwise direction in FIG. 1).

The guide portion 30 is provided with a first guide portion 31, a second guide portion 32, and a third guide portion 33 that configure a transport pathway of the medium M from upstream in the transport direction to downstream in the transport direction. The first guide portion 31 guides the medium M fed out from the feed out portion 20 toward the second guide portion 32, the second guide portion 32 guides (supports) medium M on which printing is performed, and the third guide portion 33 guides medium M on which printing is finished downstream in the transport direction.

The transport portion 40 is provided with a transport roller 41 that applies a transport force for transporting the medium M in the transport direction F, to the medium M, a pressing portion 60 that presses down the medium M on the transport roller 41, and a transport motor 42 that drives the transport roller 41.

The transport roller 41 is a roller in which the width direction X is set as the axial direction thereof. In addition, the transport roller 41 is disposed vertically below the transport pathway of the medium M, and supports the medium M from vertically below. For this reason, in the present embodiment, the transport roller 41 is equivalent to an example of a “support portion”. On the other hand, the pressing portion 60 is disposed vertically above the transport pathway of the medium M. Further, in the transport portion 40, the medium M is transported in the transport direction F as a result of the transport roller 41 being caused to rotate in a state in which the medium M is held between the transport roller 41 and the pressing portion 60.

The printing portion 50 is provided with a guide shaft 51 in which the width direction X is set as the axial direction thereof, a carriage 52 that is supported by the guide shaft 51, and a printing head 53 that discharges an ink onto the medium M. The carriage 52 reciprocates in the width direction X along the guide shaft 51 as a result of the driving of a carriage motor, which is not illustrated in the drawings. In addition, the printing head 53 is supported by the carriage 52 so that an opening of a nozzle that discharges the ink faces the medium M supported by the second guide portion 32. Further, in the printing portion 50, printing of a single pass is performed on medium M transported in the transport direction F as a result of the ink being discharged from the printing head 53 while the carriage 52 is moved in the width direction X.

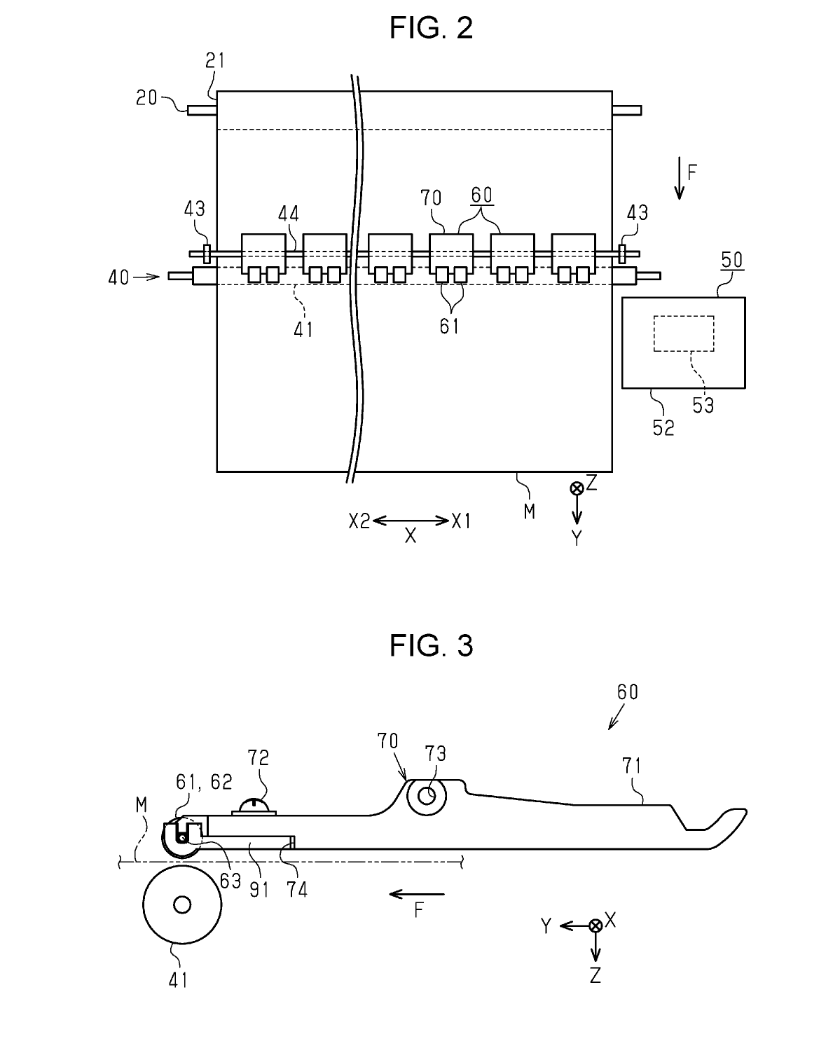

Next, the pressing portion 60 will be described in detail with reference to FIGS. 2 to 5.

As shown in FIG. 2, a plurality of the pressing portions 60 are provided aligned in the width direction X. In addition, the plurality of pressing portions 60 are supported so as to be capable of rotating by a support shaft 44, which is provided in a hanging manner throughout the entirety of the width direction X on a support frame 43 provided on both sides in the width direction X of the transport pathway of the medium M.

As shown in FIGS. 3 to 5, the pressing portion 60 is provided with a pressing roller 61 that is capable of rotating with the width direction X set as the axial direction thereof, and a roller support portion 70 that supports the pressing roller 61. In this instance, in the present embodiment, due to the fact that a plurality of the pressing portions 60, which are provided with the pressing roller 61, are provided, it can be said that a plurality of pressing rollers 61 are provided.

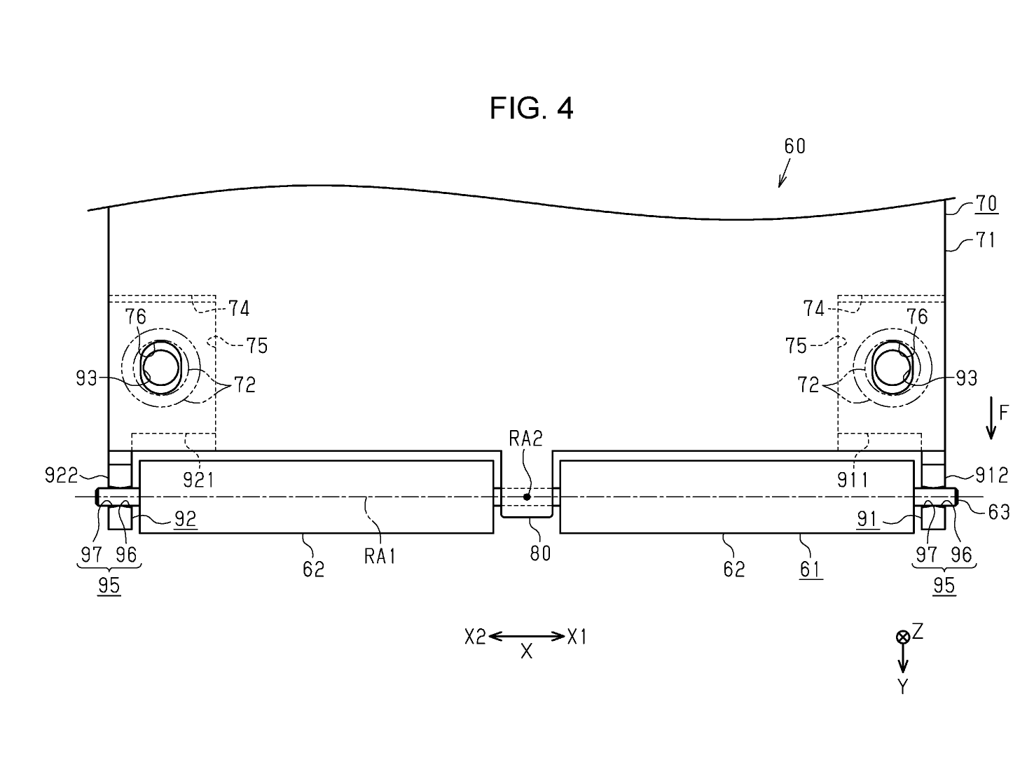

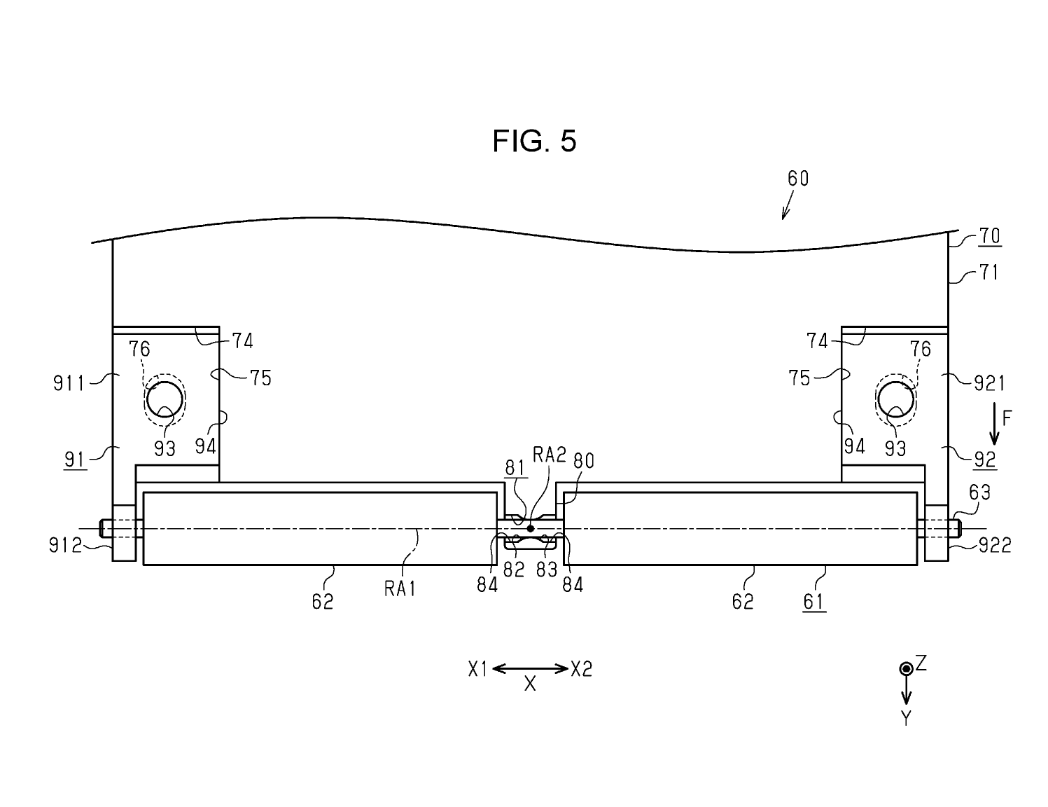

The pressing roller 61 is supported by the tip end of the roller support portion 70. In addition, as shown in FIGS. 4 and 5, the pressing roller 61 includes a plurality (two in the present embodiment) of roller members 62, and a connecting shaft 63 that connects the roller members 62 at an interval in the axial direction thereof. The roller members 62 have substantially columnar form in which the width direction X is set as the axial direction thereof. Both end portions in the axial direction of the connecting shaft 63 project from the roller members 62.

As shown in FIGS. 3 to 5, the roller support portion 70 includes a main body 71, a first arm 91 that supports an end portion of the first end X1 side of the pressing roller 61 so as to be capable of rotating, a second arm 92 that supports an end portion of the second end X2 side of the pressing roller 61 so as to be capable of rotating, and fixing members 72 that fix the first arm 91 and the second arm 92 to the main body 71.

As shown in FIGS. 4 and 5, the main body 71 has a substantially rectangular plate form in which the vertical direction Z is set as the thickness direction thereof. As shown in FIG. 3, an insertion hole 73 for inserting the support shaft 44 is formed passing through in the width direction X at the substantial center in the transport direction F of the main body 71. In this manner, the main body 71 is capable of swinging with the support shaft 44 set as the swinging center thereof.

In addition, as shown in FIG. 4, a central shaft bearing portion 80 that supports a central portion in the axial direction of the pressing roller 61 (the connecting shaft 63), is provided in the center in the width direction X of the tip end portion of the main body 71 so as to project downstream in the transport direction. That is, the central shaft bearing portion 80 is provided between the first arm 91 and the second arm 92 in the width direction X.

In addition, as shown in FIG. 5, concave portions 74 into which the first arm 91 and the second arm 92 are fitted, are provided on both sides in the width direction X of the tip end portion of the main body 71 so as to have a vertically upward concave form. The concave portions 74 have a rectangular shape when viewed in a planar manner, and guide surfaces 75, which follow the transport direction F, are formed on a central side in the width direction X. In addition, long holes 76, in which the transport direction F is set as the longitudinal direction thereof, are opened in the substantial center of the concave portions 74 when viewed in a planar manner. That is, the long holes 76 are formed passing through the thickness direction of the main body 71.

As shown in FIG. 5, a groove 81, which runs vertically upward from a vertically lower portion, is formed in the central shaft bearing portion 80 throughout the entirety of the width direction X. Therefore, the central shaft bearing portion 80 has an inverted U-shape when viewed in a lateral manner. In addition, the groove 81 of the central shaft bearing portion 80 includes a tapered groove 82 in which the opening length in the transport direction F increases with progression toward the first end X1, a tapered groove 83 in which the length in the transport direction F increases with progression toward the second end X2, and parallel grooves 84 in which the opening length in the transport direction F does not change throughout the width direction X. In the central shaft bearing portion 80, the tapered groove 82 and a parallel groove 84 are formed running from the center toward the first end X1, and the tapered groove 83 and a parallel groove 84 are formed running from the center toward the second end X2.

As shown in FIG. 5, the first arm 91 includes a first fixing plate 911 having a rectangular plate form, and a first shaft bearing portion 912 provided in one end portion in the longitudinal direction of the first fixing plate 911. In a similar manner, the second arm 92 includes a second fixing plate 921 having a rectangular plate form, and a second shaft bearing portion 922 provided in one end portion in the longitudinal direction of the second fixing plate 921.

As shown in FIGS. 4 and 5, screw holes 93 are formed in the substantial centers in the plan view in the first fixing plate 911 and the second fixing plate 921. The screw holes 93 correspond to the long holes 76 of the main body 71, and are in communication with the long holes 76 when the first fixing plate 911 or the second fixing plate 921 are accommodated in the concave portions 74 of the main body 71. Further, the first arm 91 is fixed to the main body 71 by screwing the fixing member 72, which is inserted through the long hole 76 on the first end X1 side of the main body 71, through the screw hole 93 of the first fixing plate 911. In a similar manner, the second arm 92 is fixed to the main body 71 by screwing the fixing member 72, which is inserted through the long hole 76 on the second end X2 side of the main body 71, through the screw hole 93 of the second fixing plate 921. Incidentally, for example, the fixing members 72 may be configured by a pan head screw and lock washer. In addition, as shown in FIG. 5, target guide surfaces 94, which follow the transport direction F, are formed on the central sides in the width direction X of the first fixing plate 911 and the second fixing plate 921.

Further, in the roller support portion 70, the amount of protrusion in the transport direction F of the first arm 91 and the second arm 92 with respect to the main body 71 is altered by changing fixing positions of the first arm 91 and the second arm 92 with respect to the main body 71 using the fixing member 72. For this reason, it can be said that the first arm 91 and the second arm 92 of the present embodiment can be moved along the transport direction F. Additionally, in a case in which the amounts of protrusion in the transport direction F of the first arm 91 and the second arm 92 with respect to the main body 71 is changed, the target guide surfaces 94 of the first arm 91 and the second arm 92 slide along the guide surfaces 75 of the concave portions 74 of the main body 71.

In addition, as shown in FIG. 4, grooves 95, which run vertically downward from a vertically upper portion, are formed in the first shaft bearing portion 912 of the first arm 91 and the second shaft bearing portion 922 of the second arm 92. Therefore, as shown in FIG. 3, the first shaft bearing portion 912 and the second shaft bearing portion 922 have U-shapes when viewed in a lateral manner.

To explain in more detail, as shown in FIG. 4, the grooves 95 of the first shaft bearing portion 912 and the second shaft bearing portion 922 include tapered grooves 96 in which the opening length in the transport direction F increases with progression toward the first end X1, and tapered grooves 97 in which the opening length in the transport direction F increases with progression toward the second end X2. In the first shaft bearing portion 912 and the second shaft bearing portion 922, the tapered grooves 96 are formed on the first end X1 side, and the tapered grooves 97 are formed on the second end X2 side.

Further, as shown in FIGS. 4 and 5, in the pressing portion 60 of the present embodiment, the pressing roller 61 is supported by the first shaft bearing portion 912 of the first arm 91, the second shaft bearing portion 922 of the second arm 92, and the central shaft bearing portion 80. To explain in more detail, the first shaft bearing portion 912 and the second shaft bearing portion 922 support the end portions of the pressing roller 61 (the connecting shaft 63) from vertically below, and the central shaft bearing portion 80 supports the central portion of the pressing roller 61 (the connecting shaft 63) from vertically above.

In this manner, in the pressing portion 60 of the present embodiment, the pressing roller 61 is configured to be capable of rotating with an axis of rotation RA1, in which the width direction X is set as the axial direction thereof, set as the center thereof. Furthermore, in the present embodiment, the pressing roller 61 is configured to be capable of revolving with an axis of revolution RA2, in which a direction (the vertical direction Z in the present embodiment) that intersects (is orthogonal to) both directions of the transport direction F and the width direction X, is set as the axial direction thereof, set as the center thereof depending on movement in the transport direction F of the first arm 91 and the second arm 92 of the roller support portion 70.

That is, the roller support portion 70 of the present embodiment supports the pressing roller 61 so as to be capable of rotating around the axis of rotation RA1 with the width direction X set as the axial direction thereof, and supports the pressing roller 61 so as to be capable of revolving around the axis of revolution RA2 with the direction that intersects (is orthogonal to) both directions of the axial direction thereof (the width direction X) and the transport direction F, set as the axial direction thereof. Additionally, after the pressing roller 61 is caused to revolve around the axis of revolution RA2, the axial direction of the axis of rotation RA1 becomes inclined from the width direction X. Therefore, the roller support portion 70 is also a portion that supports the pressing roller 61 before and after revolution so as to be capable of rotating around the axis of rotation RA1.

Additionally, in the present embodiment, the term “rotation” is used in a case in which the pressing roller 61 rotates around the axis of rotation RA1, in which the width direction X is set as the axial direction thereof, and the term revolution is used in a case in which the pressing roller 61 revolves around the axis of revolution RA2 in which the direction that intersects both directions of the axial direction thereof (the width direction X) and the transport direction F is set as the axial direction thereof.

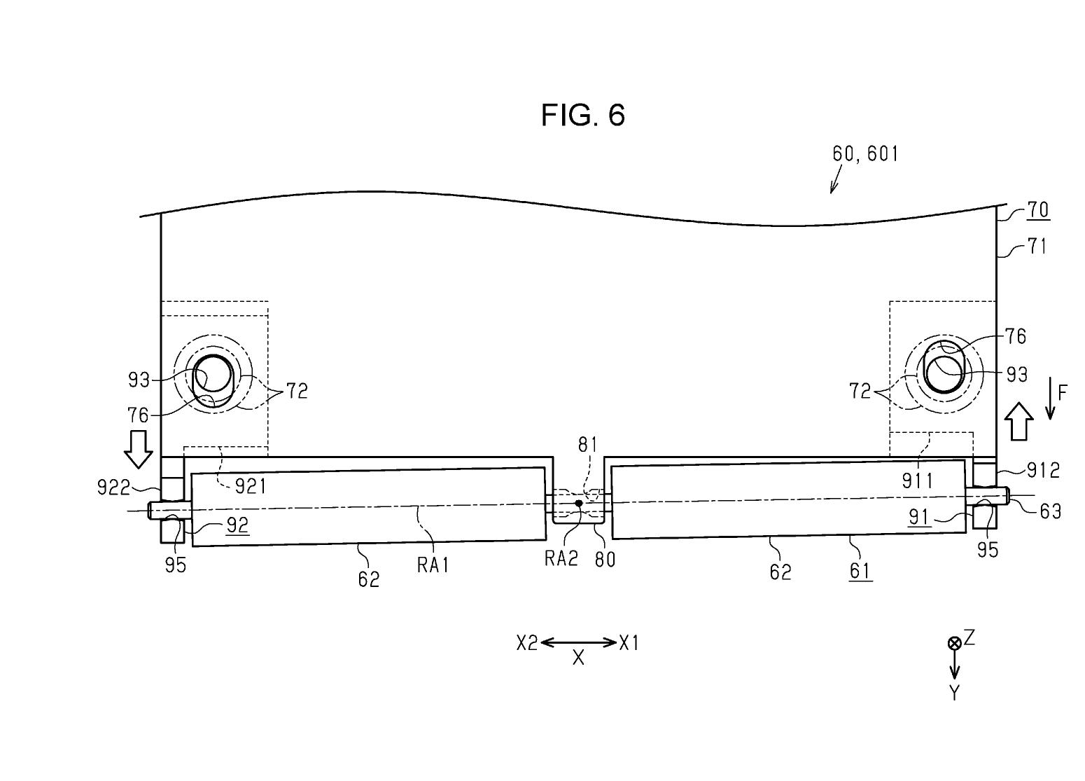

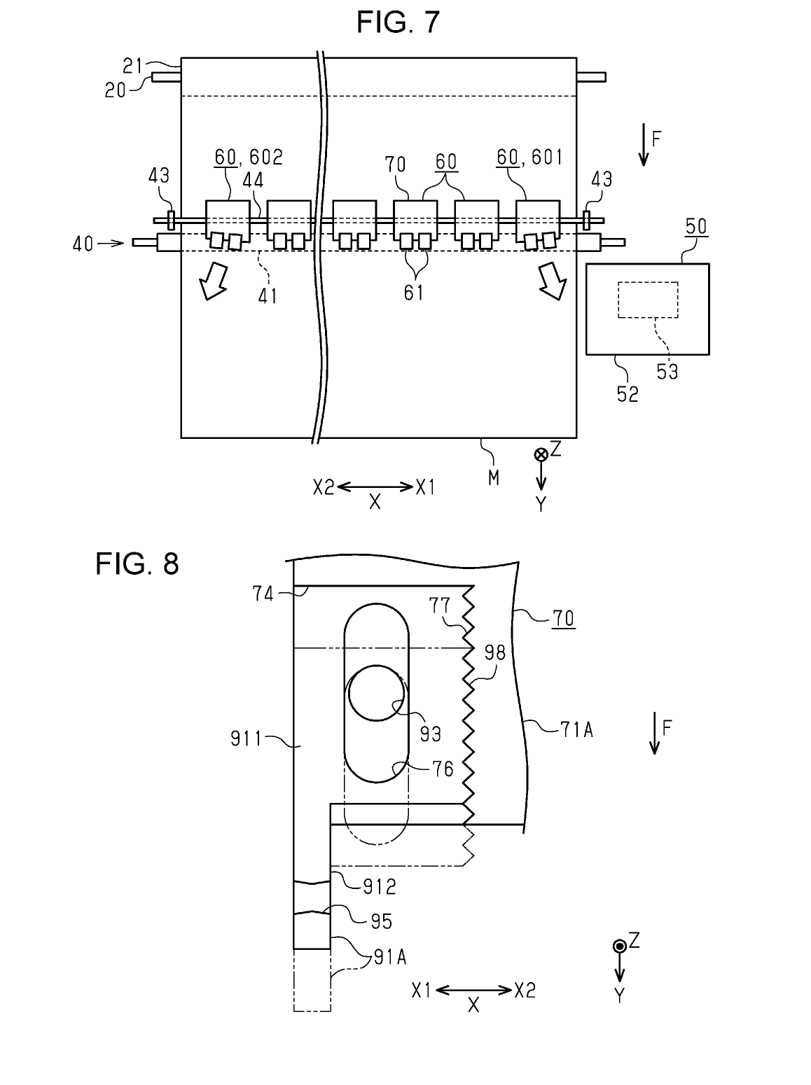

Next, the actions of the printing apparatus 10 of the present embodiment will be described with reference to FIGS. 6 and 7.

Meanwhile, in the printing apparatus 10 of the present embodiment, adjustment of the transport portion 40 is performed before printing on the medium M is initiated. That is, in the transport portion 40, the pressing rollers 61 of the pressing portions 60 that are disposed on both outer sides in the width direction X are revolved so as to be directed toward the outer side in the width direction X. In other words, the axial directions of the pressing rollers 61 are revolved so as to be inclined downstream in the transport direction with progression toward the central side from the outer sides in the width direction X.

Hereinafter, a state of revolution of the pressing rollers 61 of the pressing portions 60 will be described in detail. Additionally, except for the orientation of the revolution, the states of revolution of the pressing rollers 61 of the pressing portion 60 (hereinafter, also referred to as a “pressing portion 601”) that is disposed on the first end X1 side and the pressing roller 61 of the pressing portion 60 (hereinafter, also referred to as a “pressing portion 602”) that is disposed on the second end X2 side are made to be substantially equivalent. Therefore, in the following description, a state of revolution of the pressing roller 61 of the pressing portion 601 that is disposed on the first end X1 side will be described.

As shown by the white outlined arrow in FIG. 6, in the pressing roller 61 of the pressing portion 601 that is disposed on the first end X1 side, the first arm 91 is fixed in a state of being moved upstream in the transport direction, and the second arm 92 is fixed in a state of being moved downstream in the transport direction due to operation by a user of the printing apparatus 10.

If this occurs, the pressing roller 61 of the pressing portion 601 revolves with the axis of revolution RA2, which is the axis of revolution RA2 in which a direction (the vertical direction Z in the present embodiment) that intersects both directions of the transport direction F and the width direction X is set as the axial direction thereof, and which is positioned between the first end X1 and the second end X2 of the pressing roller 61, set as the center thereof. That is, the pressing roller 61 of the pressing portion 601 is revolved so that the axial direction of the pressing roller 61 becomes inclined downstream in the transport direction with progression toward the central side from the outer sides in the width direction X.

Additionally, as shown in FIG. 6, in the pressing portion 601, since the pressing roller 61 revolves around the axis of revolution RA2, which is orthogonal to the transport direction F, as a result of the first arm 91 and the second arm 92 moving in the transport direction F, a relative angular relationship between the first arm 91, the second arm 92, and the central shaft bearing portion 80, and the pressing roller 61 changes. For this reason, in the present embodiment, in the central shaft bearing portion 80, and the first arm 91 and the second arm 92, since the grooves 81 and 95, which support the pressing roller 61, include the tapered grooves 82, 83, 96, and 97, revolution of the pressing roller 61 is allowed in a state in which the pressing roller 61 is supported by the first arm 91, the second arm 92, and the central shaft bearing portion 80. In addition, in a state in which the pressing roller 61 is revolved, rotation around the axis of rotation RA1 is allowed.

In this manner, as shown in FIG. 7, printing on the medium M is initiated when the pressing rollers 61 of the pressing portion 601 and the pressing portion 602 that are disposed on both outer sides in the width direction X, are revolved so as to become directed toward the outer side in the width direction X. That is, printing is performed as a result of the medium M fed out from the rolled body 21 being transported in the transport direction F, and the ink being discharged onto the medium M.

Further, when the pressing rollers 61, which are revolved in this manner, are driven to rotate in the accordance with transport of the medium M, as shown by the white outlined arrow in FIG. 6, a force that stretches the medium M to the outer side in the width direction X, acts on the medium M. Therefore, even in a case in which sagging or lifting occurs in the medium M in the width direction X due to expansion, or the like, of medium M that has absorbed the ink, since such sagging or lifting is elongated in the width direction X, it is unlikely that wrinkling will occur between the pressing rollers 61 of adjacent pressing portions 60.

On the other hand, in the present embodiment, since the axial direction of a pressing roller 61 is not orthogonal to the transport direction F, due to friction with medium M, a force that changes the angle of revolution of the pressing roller 61, acts on the pressing roller 61. However, in the present embodiment, since the first arm 91 and the second arm 92, which support both end portions in the width direction X of the pressing roller 61, are fixed to the main body 71 using the fixing members 72, revolution of the pressing roller 61 that accompanies transport of the medium M, is suppressed. For this reason, in the present embodiment, the fixing members 72 are equivalent to an example of a “regulation portion” that regulates revolution of the pressing roller 61.

In addition, in the pressing portion 601 and the pressing portion 602, as a result of the movement amounts upstream in the transport direction of the first arms 91 and the movement amounts downstream in the transport direction of the second arms 92 being equivalent, the axes of revolution RA2 (the centers of revolution) of the pressing rollers 61 are positioned between both end portions in the axial directions of the pressing rollers 61, or to explain in more detail, are positioned in the centers in the axial directions of the pressing rollers 61. Therefore, the revolving ranges of the pressing rollers 61 are smaller than a case in which the end portions in the width direction X of the pressing rollers 61 are set as the centers of revolution thereof, and a case in which portions that are further on the outer sides than the end portions in the width direction X of the pressing rollers 61 are set as the centers of revolution.

Furthermore, as a result of the movement amounts upstream in the transport direction of the first arms 91 and the movement amounts downstream in the transport direction of the second arms 92 being equivalent, the distances between the first ends X1 of the pressing rollers 61 and the transport roller 41, and the distances between the second ends X2 of the pressing rollers 61 and the transport roller 41 in the transport direction F are equivalent. Therefore, a state that can hold the medium M between the transport roller 41 and the pressing rollers 61 is retained, and a circumstance in which the transport force that is applied to the medium M, is reduced, is suppressed.

According to the abovementioned embodiment, it is possible to obtain the following effects.

(1) The medium M is transported in a state in which pressing rollers 61 of pressing portions 60 that are disposed further on the outer sides than a central position of the medium M in the width direction X are revolved so as to be directed toward the outer sides in the width direction X. Therefore, when the pressing rollers 61 rotate in accordance with transport of the medium M, it is possible to cause a force that stretches the medium M to the outer side in the width direction X, to act on the medium M. Therefore, even in a case in which sagging or lifting occurs in the medium M in the width direction X, since such sagging or lifting is elongated in the width direction X, it is possible to make it unlikely for wrinkling to occur between adjacent pressing rollers 61.

(2) In a case in which the pressing rollers 61 press the medium M down toward the transport roller 41, when the axes of rotation RA1 of the pressing rollers 61 and an axis of rotation of the transport roller 41 are positioned separated from one another in the transport direction F, it is no longer possible to hold the medium M between the pressing rollers 61 and the transport roller 41, and therefore, it is likely that the transport force that the transport roller 41 can apply to the medium M is small. For this reason, in the present embodiment, since the axis of revolution RA2 of a pressing roller 61 is positioned between both end portions in the axial direction of the pressing roller 61, even if the pressing roller 61 is caused to revolve, it is possible to retain a state in which the medium M is held between the pressing roller 61 and the transport roller 41. Therefore, it is possible to suppress a circumstance in which the transport force that the transport roller 41 can apply to the medium M deteriorates.

(3) The pressing rollers 61 are revolved so that the centers of revolution (the axes of revolution RA2) are positioned in the center in the axial directions of the pressing rollers 61. Therefore, it is possible to suppress an increase in the distance between the second ends X2 of the pressing rollers 61 and the transport roller 41 while suppressing an increase in the distance between the first ends X1 of the pressing rollers 61 and the transport roller 41 in the transport direction F. Accordingly, the amount of positional shift in the transport direction F of the pressing rollers 61 with respect to the transport roller 41 is suppressed, and therefore, it is possible to suppress a circumstance in which the transport accuracy of the medium M deteriorates.

(4) The first ends X1 of the pressing rollers 61 are supported by the first arms 91, which are capable of moving in the transport direction F, and the second ends X2 of the pressing rollers 61 are supported by the second arms 92, which are capable of moving in the transport direction F. Therefore, as a result of moving the second arms 92 in one direction in the transport direction F while moving the first arms 91 in the other direction in the transport direction F, it is possible to easily cause the pressing rollers 61 to revolve around the axes of revolution RA2.

(5) When a pressing roller 61 is revolved, there is a concern that the angle of revolution of the pressing roller 61 will be unintentionally changed as a result of a friction force with the medium M that is transported acting on the pressing roller 61. For this reason, in the present embodiment, since the first arm 91 and the second arm 92, which support both end portions of the pressing rollers 61, are fixed to the main body 71 using the fixing members 72, revolution of the pressing rollers 61 is regulated even if a friction force with the medium M that is transported, acts on the pressing rollers 61. In this manner, it is possible to suppress a circumstance in which the angle of revolution of the pressing rollers 61 is unintentionally changed.

Additionally, the abovementioned embodiment may be altered in the following manner.
In the pressing portions 60 of the above-mentioned embodiment, the first arm 91 and the second arm 92 may be configured to be capable of moving gradually with respect to the main body 71. Hereinafter, a specific configuration will be described with reference to the bottom view shown in FIG. 8. Additionally, in the description from this point onwards, the configuration relating to the first arms 91 will be described, and the description of the configuration relating to the second arm 92 will be omitted.

As shown in FIG. 8, an engagement portion 77, which has a triangular wave shape in which waves are formed at a fixed period (pitch) along the transport direction F, is formed on the central side in the width direction X of the concave portion 74 of a main body 71A. In this instance, as shown in FIG. 8, the term “triangular wave shape” refers to a concavo-convex shape in which a plurality of triangular forms are aligned. More specifically, the triangular wave shape is configured as a result of inverted V-shaped convex portions and V-shaped concave portions being alternately formed. In addition, a target engagement portion 98 that has a triangular wave shape in which waves are formed at a period (pitch) along the transport direction F that is equivalent to that of the engagement portion 77 of the main body 71A, is formed on the central side in the width direction X of the first fixing plate 911 of the first arm 91A.

Further, a relative positional relationship of a first arm 91A and the main body 71A is established as a result of the target engagement portion 98 of the first arm 91A engaging with the engagement portion 77 of the concave portion 74 on the first end X1 side of the main body 71A. In addition, since the engagement portion 77 of the main body 71A and the target engagement portion 98 of the first arm 91A have periodic structures along the transport direction F, as shown by the dashed-two dotted line in FIG. 8, the first arm 91A is capable of causing the target engagement portion 98 to engage with the engagement portion 77 in a state in which the relative positional relationship with respect to the main body 71A is changed.

According to such a configuration, it is more likely for a movement amount of one arm in one direction in the transport direction F, and a movement amount of the other arm in the other direction in the transport direction F to be equivalent. For example, in a case in which one arm is moved by an amount corresponding to three convex portions in the transport direction F, it is possible to make the movement amount of the one arm and the movement amount of the other arm equivalent by moving the other arm by an amount corresponding to three convex portions in the transport direction F.

In addition, it is possible to cause the pressing rollers 61 to revolve gradually around the axes of revolution RA2 by moving both arms gradually. Therefore, it is easy to set the angles of revolution to be equivalent, to provide a predetermined difference in angles in the angles of revolution, or the like for a pressing roller 61 of one pressing portion 60 and a pressing roller 61 of another pressing portion 60 among the plurality of pressing portions 60.
The engagement portion 77 and the target engagement portion 98 may have another configuration as long as it is possible to displace both arms gradually in the transport direction F with respect to the main body 71. For example, one of the engagement portion 77 and the target engagement portion 98 may be configured as a rack and the other as a pinion. According to such a configuration, it is possible to determine the movement amounts of the first arm 91 and the second arm 92 with respect to the main body 71 depending on the rotational amount of the pinion.
The movement amounts in the transport direction F of the first arm 91 and the second arm 92 may differ when the pressing roller 61 is revolved. For example, the first arm 91 may be moved by an amount corresponding to a first movement amount in the transport direction F, and the second arm 92 may be moved by an amount corresponding to a second movement amount, which is greater than the first movement amount, in a direction that is opposite to the transport direction F. Furthermore, the first arm 91 may be moved by an amount corresponding to a first movement amount in the transport direction F, and the second arm 92 may be moved by an amount corresponding to a second movement amount, which is greater than the first movement amount, in the transport direction F. In such a case, the axes of revolution RA2 of the pressing rollers 61 are positioned close to an arm in which the movement amount in the transport direction F is smaller. In other words, the axis of revolution RA2 of a pressing roller 61 need not necessarily be positioned in the center of the first ends X1 and the second ends X2 of the pressing roller 61.
The transport roller 41 may be a transport belt that is wound around a plurality of belt rollers in which the width direction X is set as the axial direction thereof. Even in this case, it is possible to obtain the effects of the above-mentioned embodiment.
For example, the subject (a support portion) onto which the pressing rollers 61 press the medium M down may be a support member having a support surface that supports the medium M in the manner of the second guide portion 32. Even in this case, it is possible to obtain an equal effect to that of effect (1) of the above-mentioned embodiment.
The transport roller 41 may be disposed vertically above the transport pathway of the medium M, and the pressing portions 60 may be disposed vertically below the transport pathway of the medium M.

The first arm 91 and the second arm 92 need not necessarily be provided. In this case, the central shaft bearing portion 80 may be configured as a rolling bearing that supports the transport roller 41 so as to be capable of rotating, and the transport roller 41 may be caused to revolve by causing the rolling shaft bearing to revolve around the axis of revolution RA2 in the above-mentioned embodiment.
The axis of revolution RA2 need not necessarily have a direction (the vertical direction Z in the present embodiment) that is orthogonal to both directions of the width direction X and the transport direction F set as the axial direction thereof. That is, the axis of revolution RA2 may have a direction that is slightly inclined from a direction that is orthogonal to both directions of the width direction X and the transport direction F, set as the axial direction thereof.
Revolving the pressing rollers 61 so that the axial directions of the pressing rollers 61 are axial directions that proceed to the second end X2 with progression toward the transport direction F in the manner of the pressing rollers 61 at the first end X1 in FIG. 7, is referred to as “revolving toward the first end X1 side”. In addition, revolving the pressing rollers 61 so that the axial directions of the pressing rollers 61 are axial directions that proceed to the first end X1 with progression toward the transport direction F in the manner of the pressing rollers 61 at the second end X2 in FIG. 7, is referred to as “revolving toward the second end X2 side”.

In this case, all of the pressing rollers 61 disposed further on the first end X1 side than the center of the medium M in the width direction X may be revolved toward the first end X1 side, and all of the pressing rollers 61 disposed further on the second end X2 side than the center of the medium M may be revolved toward the second end X2 side. In addition, two or more of the pressing rollers 61 disposed further on the first end X1 side than the center of the medium M may be revolved toward the first end X1 side, and two or more of the pressing rollers 61 disposed further on the second end X2 side than the center of the medium M may be revolved toward the second end X2 side.

In addition, in a case in which all of the pressing rollers 61 disposed further on the first end X1 side than the center of the medium M in the width direction X are revolved toward the first end X1 side, the angle of revolution may increase in tandem with pressing rollers 61 that are disposed far from the center of the medium M. In addition, in a case in which all of the pressing rollers 61 disposed further on the second end X2 side than the center of the medium M in the width direction X are revolved toward the second end X2 side, the angle of revolution may increase in tandem with pressing rollers 61 that are disposed far from the center of the medium M.
The pressing rollers 61 may be provided with a single roller member 62, or may be provided with three or more roller members 62. In a case in which the pressing rollers 61 are provided with a single roller member 62, the central shaft bearing portion 80 need not necessarily be provided.
The configurations of the pressing portion 60 disposed on the first end X1 side and the pressing portion 60 disposed on the second end X2 side, and the pressing portions 60 disposed between these pressing portions 60 may differ. That is, the pressing portions 60 disposed between the pressing portions 60 disposed in both end portions in the width direction X may be configured to be pressing portions in which it is not possible for the pressing rollers 61 to revolve.
The second guide portion 32 may support the medium M aligned with the center in the width direction X, or may support the medium M aligned to an end to coincide with a guide member provided either at the first end X1 or the second end X2 in the width direction X.
A movement mechanism that can move the first arm 91 and the second arm 92 in the transport direction F may be further provided, and the first arm 91 and the second arm 92 may be moved regardless of operation by a user. In this case, an actuator such as a solenoid may be used as the movement mechanism.
The fixing members 72 as an example of a regulation portion may be joining members other than screws. For example, the fixing members 72 may be configured as a bolt and a nut.
The medium M is not limited to sheets of paper, and may be a fabric or a resin film. In addition, the medium M need not necessarily be a longitudinal medium M that is fed out from the rolled body 21. For example, the medium M may be single sheet paper.
The printing head 53 may be a so-called line head that is longer in the width direction X than the length in the width direction X of all of the media M that the printing apparatus 10 sets as a printing target, and that is disposed in the printing apparatus 10 in a fixed manner.
In the above-mentioned embodiment, the recording material used in printing may be a fluid other than ink (including a liquid, a liquid form body in which particles of a functional material are dispersed in or mixed into a liquid, a fluid form body such as a gel, and a solid body that can be fluidified and discharged as fluid). For example, a configuration that performs recording by discharging a liquid form body including a material such as an electrode material or a color material (a pixel material), which is used in the manufacture of a liquid crystal display, an electroluminescence (EL) display, a surface-emitting display, or the like, in a dispersed or dissolved form, may be used.
In the above-mentioned embodiment, the printing apparatus 10 is not limited to a printer that performs recording by discharging an ink, and for example, may be a laser printer, an LED printer, a non-impact printer such as a thermal transfer printer (including a dye-sublimation printer), or may be an impact printer such as a dot impact printer.

This application claims priority under 35 U.S.C. §119 to Japanese Patent Application No. 2016-049203, filed Mar. 14, 2016. The entire disclosure of Japanese Patent Application No. 2016-049203 is hereby incorporated herein by reference.

What is claimed is:

1. A printing apparatus comprising:
a printing portion that performs printing on a medium transported in a transport direction;
a support portion that supports the medium;
a plurality of pressing rollers that are capable of rotating with a width direction, which intersects the transport direction, set as an axial direction and that press the medium down toward the support portion; and
a roller support portion that supports the pressing rollers so as to be capable of revolving with an axis of revolution, which is an axis of revolution in which a direction that intersects both directions of the transport direction and the width direction is set as an axial direction thereof and which is positioned between an end portion of a first end side and an end portion of a second end side in the axial direction of the pressing rollers, set as a center thereof.

2. The printing apparatus according to claim 1,
wherein the support portion is a transport roller that rotates with the width direction as an axial direction thereof, and applies a transport force for transporting the medium in the transport direction, to the medium.

3. The printing apparatus according to claim 2,
wherein the axis of revolution of the pressing rollers is positioned in a center in the axial direction of the pressing rollers.

4. The printing apparatus according to claim 1,
wherein the roller support portion includes
a first arm that supports the end portion of the first end side of the pressing rollers in the width direction so as to be capable of rotating, and that can be moved along the transport direction, and
a second arm that supports the end portion of the second end side of the pressing rollers in the width direction so as to be capable of rotating, and that can be moved along the transport direction.

5. The printing apparatus according to claim 1,
wherein the roller support portion supports the pressing rollers so that the pressing rollers revolve gradually.

6. The printing apparatus according to claim 1,
wherein the roller support portion includes a regulation portion that regulates revolution of the pressing rollers.
